(19) United States
(12) Patent Application Publication
(10) Pub. No.: US 2024/0086272 A1
(43) Pub. Date: Mar. 14, 2024

(54) SYSTEM, METHOD AND COMPUTER-READABLE MEDIUM FOR ANOMALY DETECTION

(71) Applicant: 17LIVE Japan Inc., Tokyo (JP)

(72) Inventors: Chi-Wei LIN, Taipei City (TW); Chin-Wei LIU, Taipei City (TW)

(21) Appl. No.: 18/338,942

(22) Filed: Jun. 21, 2023

(30) Foreign Application Priority Data
Sep. 12, 2022 (JP) 2022-144468

(51) Int. Cl. G06F 11/07; G06N 3/0455; G06N 3/096

(52) U.S. Cl. CPC G06F 11/079; G06F 11/0709; G06N 3/0455; G06N 3/096

(57) ABSTRACT

The present disclosure relates to a system, a method and a computer-readable medium for anomaly detection. The method includes obtaining latency data of a first endpoint, obtaining latency data of a second endpoint, generating, by a representation learning model, reconstruction error distribution data of the latency data of the first endpoint according to the latency data of the first endpoint and the latency data of the second endpoint, obtaining new latency data of the first endpoint, obtaining new latency data of the second endpoint, generating, by the representation learning model, a reconstruction error of the new latency data of the first endpoint according to the new latency data of the first endpoint and the new latency data of the second endpoint, and generating an anomaly score for the first endpoint according to a dispersion characteristic of the reconstruction error distribution data and the reconstruction error.

### CROSS-REFERENCE TO RELATED APPLICATIONS

This application is based on and claims the benefit of priority from Japanese Patent Application Serial No. 2022-144468 (filed on Sep. 12, 2022), the contents of which are hereby incorporated by reference in its entirety.

### TECHNICAL FIELD

The present disclosure relates to anomaly detection and, more particularly, to anomaly detection for endpoints.

### BACKGROUND

Data sharing or data accessing on the Internet has become popular in our daily life There are various platforms or providers providing the service of data accessing, such as a live streaming platform providing live streaming programs. A platform (or an application/a web page) is supported by various endpoints providing various kinds of data. When an outage occurs to a platform, it is important to be able to find out the endpoints related to or responsible for the outage in an efficient manner.

### SUMMARY

A method according to one embodiment of the present disclosure is a method for anomaly detection being executed by one or a plurality of computers, and includes: obtaining latency data of a first endpoint, obtaining latency data of a second endpoint, generating, by a representation learning model, reconstruction error distribution data of the latency data of the first endpoint according to the latency data of the first endpoint and the latency data of the second endpoint, obtaining new latency data of the first endpoint, obtaining new latency data of the second endpoint, generating, by the representation learning model, a reconstruction error of the new latency data of the first endpoint according to the new latency data of the first endpoint and the new latency data of the second endpoint, and generating an anomaly score for the first endpoint according to a dispersion characteristic of the reconstruction error distribution data and the reconstruction error.

A system according to one embodiment of the present disclosure is a system for anomaly detection that includes one or a plurality of computer processors, and the one or plurality of computer processors execute a machine-readable instruction to perform: obtaining latency data of a first endpoint, obtaining latency data of a second endpoint, generating, by a representation learning model, reconstruction error distribution data of the latency data of the first endpoint according to the latency data of the first endpoint and the latency data of the second endpoint, obtaining new latency data of the first endpoint, obtaining new latency data of the second endpoint, generating, by the representation learning model, a reconstruction error of the new latency data of the first endpoint according to the new latency data of the first endpoint and the new latency data of the second endpoint, and generating an anomaly score for the first endpoint according to a dispersion characteristic of the reconstruction error distribution data and the reconstruction error.

A computer-readable medium according to one embodiment of the present disclosure is a non-transitory computer-readable medium including a program for anomaly detection, and the program causes one or a plurality of computers to execute: obtaining latency data of a first endpoint, obtaining latency data of a second endpoint, generating, by a representation learning model, reconstruction error distribution data of the latency data of the first endpoint according to the latency data of the first endpoint and the latency data of the second endpoint, obtaining new latency data of the first endpoint, obtaining new latency data of the second endpoint, generating, by the representation learning model, a reconstruction error of the new latency data of the first endpoint according to the new latency data of the first endpoint and the new latency data of the second endpoint, and generating an anomaly score for the first endpoint according to a dispersion characteristic of the reconstruction error distribution data and the reconstruction error.

### BRIEF DESCRIPTION OF THE DRAWINGS

FIG. 1 shows a schematic configuration of a communication system according to some embodiments of the present disclosure.

FIG. 2 shows an exemplary block diagram of a server in accordance with some embodiments of the present disclosure.

FIG. 3 shows examples of latency data for some endpoints.

FIG. 4 shows an exemplary data flow in accordance with some embodiments of the present disclosure.

FIG. 5 shows an exemplary data flow in accordance with some embodiments of the present disclosure.

FIG. 6 shows an exemplary flow chart in accordance with some embodiments of the present disclosure.

FIG. 7 shows an example of the endpoint data table 314.

FIG. 8 shows an example of reconstruction error distribution data for an endpoint stored in the reconstruction error distribution table 316.

FIG. 9 shows an example of the anomaly score table 318.

FIG. 10 shows an example of the system data table 320.

FIG. 11 shows an example of the correlation table 322.

FIG. 12 shows an example of anomaly detection in accordance with some embodiments of the present disclosure.

FIG. 13 shows an exemplary data flow in accordance with some embodiments of the present disclosure.

FIG. 14 shows an exemplary data flow in accordance with some embodiments of the present disclosure.

### DETAILED DESCRIPTION

When an outage, error, or anomaly occurs in a data providing system, it is important to find out the root cause as quickly as possible. Various endpoints configured for data accessing exist within a data providing system. The endpoints are often correlated with each other and it is difficult to locate or to find out the suspicious endpoint(s) that is (are) the most responsible for or the most related to an anomaly.

Conventional anomaly detection methods require engineers to check all endpoints one by one according to mere experiences. The suspicious range is broad and the detection is time consuming and inefficient.

The present disclosure discloses methods and systems to narrow down the suspicious scope and to provide the endpoints which are most likely to cause the issue. Therefore, subsequent human checks can be done in an efficient manner.

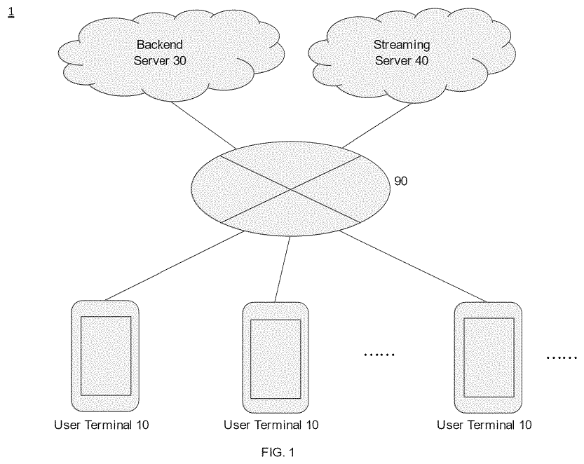

FIG. 1 shows a schematic configuration of a communication system according to some embodiments of the present disclosure.

The communication system 1 may provide a live streaming service with interaction via a content. Here, the term “content” refers to a digital content that can be played on a computer device. In other words, the communication system 1 enables a user to participate in real-time interaction with other users on-line. The communication system 1 includes a plurality of user terminals 10, a backend server 30, and a streaming server 40. The user terminals 10, the backend server 30 and the streaming server 40 are connected via a network 90, which may be the Internet, for example. The backend server 30 may be a server for synchronizing interaction between the user terminals and/or the streaming server 40. In some embodiments, the backend server 30 may be referred to as the server of an application (APP) provider. The streaming server 40 is a server for handling or providing streaming data or video data. In some embodiments, the backend server 30 and the streaming server 40 may be independent servers. In some embodiments, the backend server 30 and the streaming server 40 may be integrated into one server. In some embodiments, the user terminals 10 are client devices for the live streaming service. In some embodiments, the user terminal 10 may be referred to as viewer, streamer, anchor, podcaster, audience, listener or the like. Each of the user terminal 10, the backend server 30, and the streaming server 40 is an example of an information-processing device. In some embodiments, the streaming may be live streaming or video replay. In some embodiments, the streaming may be audio streaming and/or video streaming. In some embodiments, the streaming may include contents such as online shopping, talk shows, talent shows, entertainment events, sports events, music videos, movies, comedy, concerts or the like.

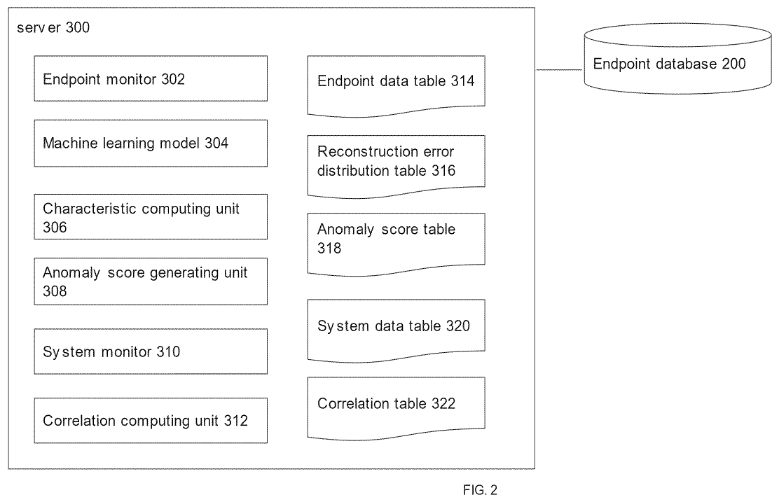

FIG. 2 shows an exemplary block diagram of a server in accordance with some embodiments of the present disclosure.

The server 300 includes an endpoint monitor 302, a machine learning model 304, a characteristic computing unit 306, an anomaly score generating unit 308, a system monitor 310, a correlation computing unit 312, an endpoint data table 314, a reconstruction error distribution table 316, an anomaly score table 318, a system data table 320, and a correlation table 322. The server 300 communicates with an endpoint database 200.

The endpoint monitor 302 is configured to obtain parameters or statuses of endpoints from the endpoint database 200. For example, the endpoint monitor 302 may obtain latency data of each endpoint from the endpoint database 200. In some embodiments, a latency for an endpoint is the time span between the timing the endpoint receives a request and the timing the endpoint transmits the corresponding response. The obtained parameters of endpoints are stored in the endpoint data table 314.

The machine learning model 304 is configured to learn a representation of its input data. For example, the machine learning model 304 is configured to learn a compressed representation of endpoint latency data which is input into the machine learning model 304. In some embodiments, the machine learning model 304 is or includes an autoencoder model, which is composed of an encoder and a decoder. In some embodiments, the encoder compresses the input data and the decoder attempts to reconstruct (or represent) the input data from the compressed version provided by the encoder. In some embodiments, the machine learning model 304 is or includes a temporal convolutional network autoencoder (TCN-Autoencoder).

In some embodiments, the machine learning model 304 is trained by historical latency data of endpoints, and tries to adjust itself to reconstruct the input data as close as possible. The machine learning model 304 also generates the difference between the input data and the reconstructed data. The difference may be referred to as the reconstruction error data.

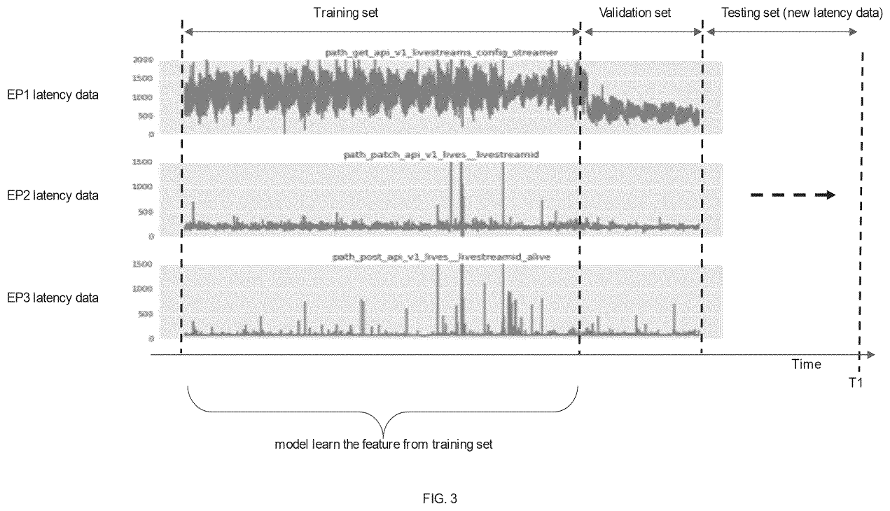

In some embodiments, the latency data of each endpoint (which is input into the machine learning model 304) includes a training set and a validation set, as shown in FIG. 3. The training set is used to train or adjust the machine learning model 304 for the reconstruction learning (or representation learning/feature learning). The validation set, which includes a plurality of latency values, is used to generate reconstruction error distribution data of the corresponding endpoint. Due to the neural network nature of the machine learning model 304, the latency data from different endpoints are correlated with each other in the learning process. Therefore, the reconstruction error distribution data of latency data of an endpoint is generated according to (or is affected by/correlated with) latency data of the endpoint and latency data of other endpoints.

The characteristic computing unit 306 is configured to compute or generate dispersion characteristics of the reconstruction error distribution data of each endpoint output by the machine learning model 304. For example, the characteristic computing unit 306 computes a 25th percentile (p25), a 75th percentile (p75), and an interquartile range (IQR) of the reconstruction error distribution data for each endpoint. In some embodiments, the reconstruction error distribution data and the dispersion characteristics are stored in the reconstruction error distribution table 316.

The anomaly score generating unit 308 is configured to generate an anomaly score for each endpoint. In some embodiments, the anomaly score of an endpoint is generated according to (1) the dispersion characteristics of the reconstruction error distribution data of the endpoint and (2) reconstruction error of (or corresponding to) new latency data of the endpoint.

The reconstruction error is generated by the machine learning model 304, with new latency data of all endpoints as the input into the machine learning model 304. For example, the reconstruction error of the new latency data of endpoint EP1 is generated by inputting the new latency data of EP1 and new latency data of other endpoints into the machine learning model 304. Therefore, the reconstruction error of the new latency data of endpoint EP1 is correlated with the new latency data of EP1 and new latency data of other endpoints.

An example of new latency data (or testing set) for each endpoint is shown in FIG. 3. The new latency data is different from the latency data used to train the machine learning model 304 or to generate the reconstruction error distribution data. In some embodiments, the new latency data refers to latency data of endpoints right before an outage occurs in a data providing system. For example, the new latency data could be one-hour latency data just before an outage occurs. In some embodiments, the new latency data can be referred to as a testing set of latency data.

In some embodiments, for an endpoint, the anomaly score is computed/defined to be: the difference between the reconstruction error (of new latency data of the endpoint) and the corresponding p75 value, then divided by the corresponding IQR. That is, the anomaly score is (reconstruction error of new latency data—p75)/IQR. Therefore, the anomaly score represents how abnormal the reconstruction error of the new latency data is with respect to the corresponding reconstruction error distribution data. The computed anomaly score for each endpoint is stored in the anomaly score table 318. In some embodiments, if the computed anomaly score is a negative number, it will be saved as zero.

In some embodiments, a higher anomaly score indicates the corresponding endpoint has a more abnormal new latency data, and therefore the corresponding endpoint may have more chance to be responsible for/relevant to the outage. The anomaly score generating unit 308 (or another filtering unit) may perform a filtering process on the endpoints by their anomaly scores to find out the suspect endpoints that may be responsible for/relevant to the outage. Subsequent human inspections, such as engineer debugging, can be performed on the suspect endpoints first.

The system monitor 310 is configured to obtain system parameters. System parameters may include CPU usage rate, memory usage rate or bandwidth of the backend server and/or the streaming server. The obtained system parameters are stored in the system data table 320.

The correlation computing unit 312 is configured to compute correlation between the system parameters and the latency data of endpoints. For example, when an outage occurs in a system, the correlation computing unit 312 computes correlation between the system parameters in the latest one hour before the outage and the latency data in the latest one hour before the outage. Therefore, we can know which endpoint is more correlated (or the most correlated) with a specific system parameter in the lastest hour before the outage. The specific system parameter could be the parameter thought to be possibly correlated with the outage, or the parameter thought to be able to reflect the outage. The computed correlation values are stored in the correlation table 322.

For example, if the outage that occurred is thought to be possibly correlated with the memory usage rate of the backend server, we may filter the endpoints by their correlation values with the memory usage rate of the backend server to find out the suspect endpoints that may be responsible for the outage. The filtering process may be performed by the correlation computing unit 312 or by another filtering unit.

In some embodiments, a first filtering is performed on all available endpoints by the anomaly scores to obtain a first group of suspect endpoints, and then a second filtering is performed on the first group of suspect endpoints by the correlation values with a system parameter to further narrow down the suspect scope. That can greatly reduce the number of suspect endpoints for subsequent human debugging, and can save time and cost.

The endpoint database 200 is configured to store parameters or statuses of endpoints. In the embodiment shown in FIG. 2, the endpoint database 200 is deployed outside the server 300. In some embodiments, the endpoint database 200 may be deployed within the server 300.

FIG. 3 shows examples of latency data for some endpoints. The latency data of each endpoint (EP) has a training set, a validation set, and a testing set (or new latency data).

In some embodiments, T1 refers to the timing of an outage. The new latency data of all endpoints are input into the machine learning model 304 to generate the reconstruction error of the new latency data of each endpoint. The validation set of all endpoints are input into the machine learning model 304 to generate the reconstruction error distribution data of each endpoint. The training set of all endpoints are used to train the machine learning model 304 to learn the corresponding features. The length of the testing set could be, for example, one hour. The length of the validation set could be, for example, one week. The length of the training set could be, for example, 3 to 4 weeks.

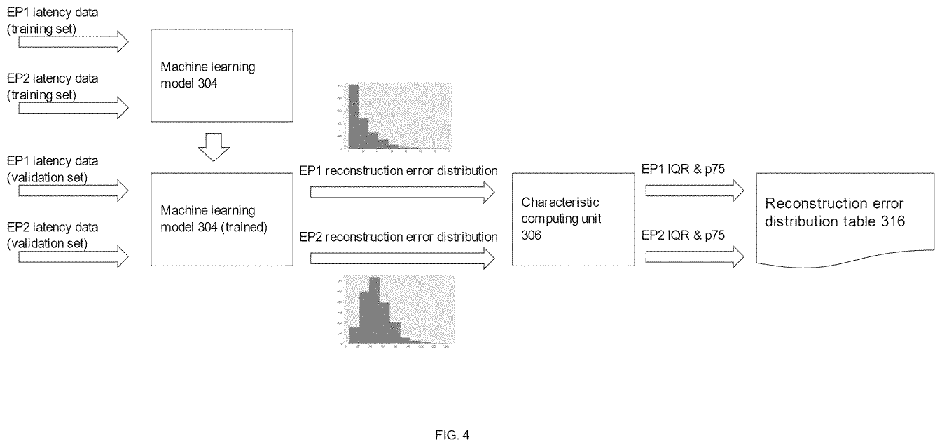

FIG. 4 shows an exemplary data flow in accordance with some embodiments of the present disclosure. Two endpoints are shown here to represent a plurality of endpoints, such as dozens, hundreds or thousands of endpoints. In some embodiments, the data flow in FIG. 4 can be referred to as a training phase of a machine learning model.

As shown in FIG. 4, training sets of latency data of all endpoints are input into the machine learning model 304 for the training of the machine learning model 304. After the training, validation sets of latency data of all endpoints are input into the machine learning model 304 to generate the reconstruction error distribution data for each endpoint. The reconstruction error distribution data for each endpoint is then input into the characteristic computing unit 306 to generate the dispersion characteristics, such as the IQR and p75 values, for each endpoint. The dispersion characteristics are then stored into the reconstruction error distribution table 316.

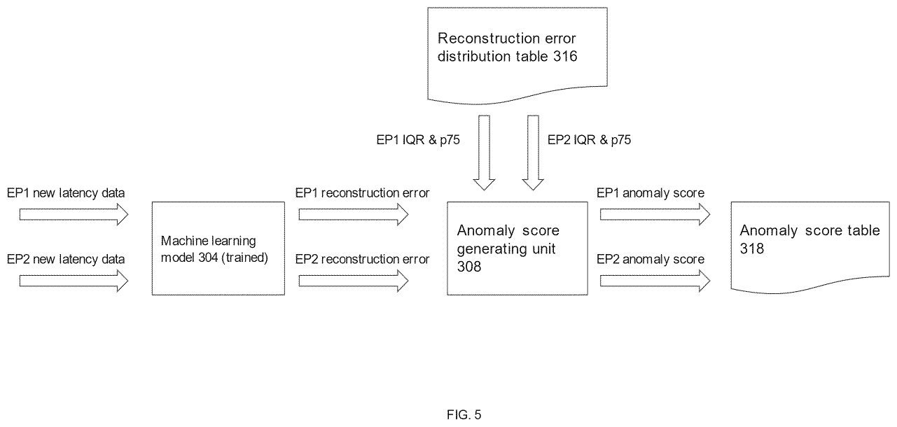

FIG. 5 shows an exemplary data flow in accordance with some embodiments of the present disclosure. Two endpoints are shown here to represent a plurality of endpoints, such as dozens, hundreds or thousands of endpoints. In some embodiments, the data flow in FIG. 5 can be referred to as an inference phase of a machine learning model.

As shown in FIG. 5, new latency data of all endpoints are input into the machine learning model 304 to generate the reconstruction error of the new latency data of each endpoint. Then, the anomaly score generating unit 308 takes the IQR and p75 values of each endpoint (from the reconstruction error distribution table 316), and the reconstruction error of the new latency data of each endpoint, as input, and delivers the anomaly score of each endpoint, as output. The anomaly scores are then stored in the anomaly score table 318.

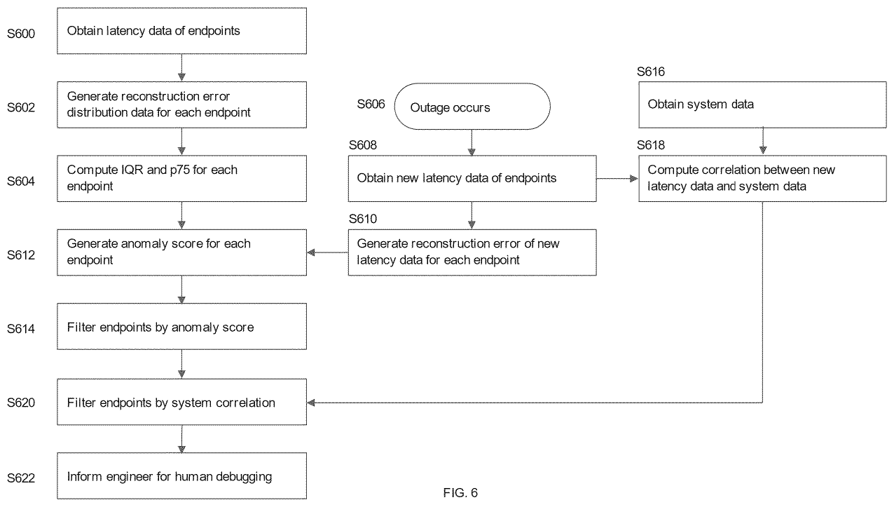

FIG. 6 shows an exemplary flow chart in accordance with some embodiments of the present disclosure. In some embodiments, it is part of an anomaly detection flow for a data providing system.

In step S600, latency data of endpoints are obtained, by the endpoint monitor 302, for example. The latency data includes training set data and validation set data for each endpoint.

In step S602, reconstruction error distribution data for each endpoint is generated, by the machine learning model 304, for example. The training sets of latency data of the endpoints are used to train the machine learning model 304. The validation sets of latency data of the endpoints are then input to the machine learning model 304 to generate the reconstruction error distribution data for each endpoint.

In step S604, dispersion characteristics such as IQR and p75 values for each endpoint are computed, by the characteristic computing unit 306, for example. Each endpoint's dispersion characteristics are computed according to the endpoint's reconstruction error distribution data.

In step S606, an outage occurs in the system.

In step S608, new latency data for each endpoint is obtained, by the endpoint monitor 302, for example. New latency data could be, for example, latency data of the endpoints during the latest one hour before the outage occurred.

In step S610, reconstruction error of each endpoint's new latency data is generated, by the machine learning model 304, for example. The new latency data of the endpoints are input into the machine learning model 304 (which has been trained by past latency data of the endpoints) to generate the reconstruction error for each endpoint.

In step S612, an anomaly score for each endpoint is computed according to the corresponding new latency data reconstruction error and the corresponding IQR and p75 values. The computation can be performed by the anomaly score generating unit 308, for example.

In step S614, the endpoints are filtered by their respective anomaly scores to generate a first group of suspect endpoints which may be responsible for/relevant to the outage. The filtering process may be performed by the anomaly score generating unit 308 or another filtering unit.

In step S616, system parameters are obtained, by the system monitor 310, for example. For example, values of system parameters for the latest one hour before the outage are obtained.

In step S618, correlation (or correlation values) between the new latency data of each endpoint and the values of each system parameter are computed, by the correlation computing unit 312, for example.

In step S620, the endpoints within the first group of suspect endpoints are filtered by their respective correlation values with one or more parameters to generate a second group of suspect endpoints which may be responsible for the outage. The filtering process may be performed by the correlation computing unit 312 or by another filtering unit.

In step S622, the suspect endpoints are reported to engineers for further debugging processes.

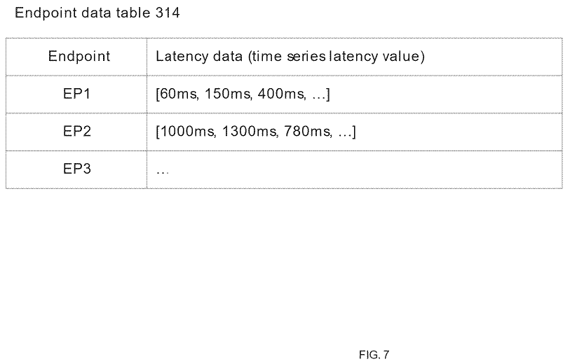

FIG. 7 shows an example of the endpoint data table 314.

In this example, endpoint EP1 is monitored to have the time series latency value sequence [60 ms, 150 ms, 400 ms, . . . ], and endpoint EP2 is monitored to have the time series latency value sequence [1000 ms, 1300 ms, 780 ms, . . . ].

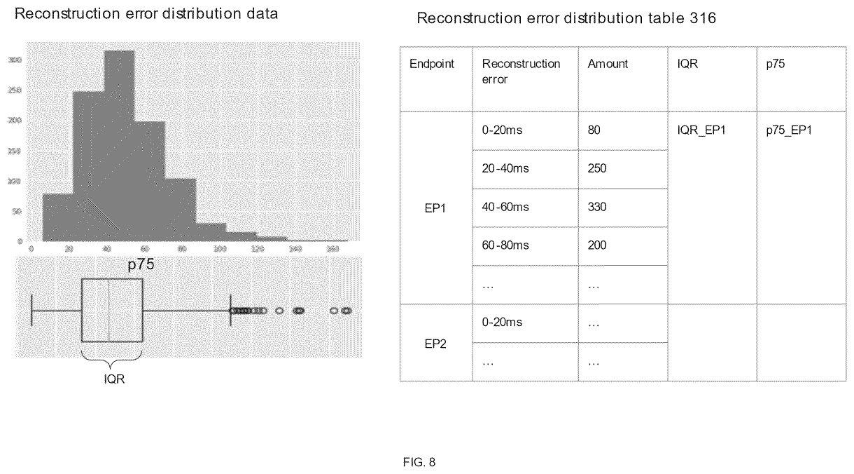

FIG. 8 shows an example of reconstruction error distribution data for an endpoint stored in the reconstruction error distribution table 316.

In this example, the reconstruction error distribution data is specified by the reconstruction errors (of the corresponding validation set data) in the X axis and their respective amounts in the Y axis. Dispersion characteristics such as IQR and p75 values are computed accordingly and stored in the reconstruction error distribution table 316 as well.

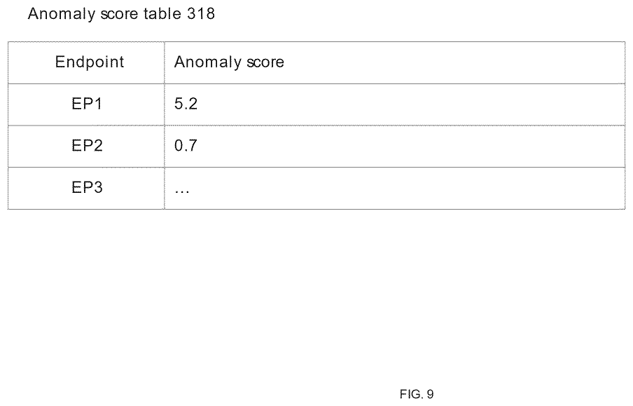

FIG. 9 shows an example of the anomaly score table 318.

The anomaly score of endpoint EP1 is 5.2. That is: (reconstruction error of new latency data of EP1-EP1's p75) is 5.2 times EP1's IQR.

The anomaly score of endpoint EP2 is 0.7. That is: (reconstruction error of new latency data of EP2-EP2's p75) is 0.7 times EP2's IQR.

In some embodiments, an anomaly score threshold can be set such that, if an anomaly score is greater than the threshold, the corresponding endpoint is classified as a suspect threshold that may be responsible for/relevant to an outage. The anomaly score threshold can be determined according to actual practice, experiments or experiences.

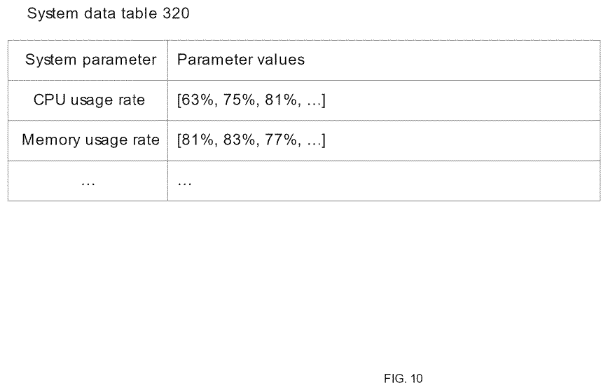

FIG. 10 shows an example of the system data table 320.

In this example, the parameter “CPU usage rate” is monitored to have the time series sequence [63%, 75%, 81%, . . . ], and the parameter “memory usage rate” is monitored to have the time series sequence [81%, 83%, 77%, . . . ]. The system could be a backend server of a data providing platform.

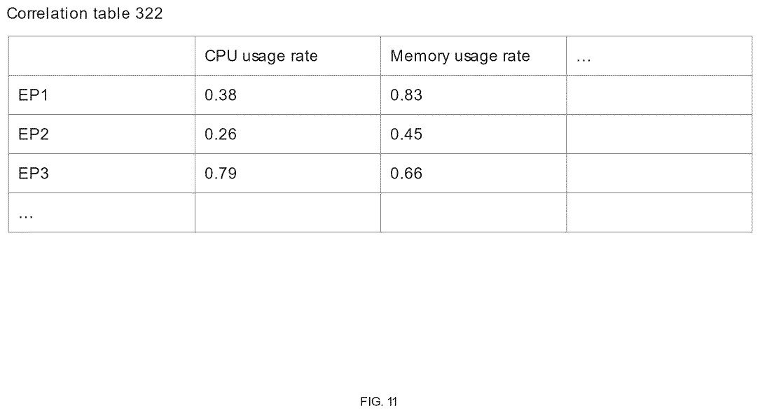

FIG. 11 shows an example of the correlation table 322.

The correlation values may be computed with latency values of each endpoint and values of each system parameter in the latest one hour before an outage. In some embodiments, a correlation threshold can be set such that, if a correlation value is greater than the threshold, the corresponding endpoint and the corresponding system parameter are determined to be correlated.

Different endpoints have different latency characteristics, which could be due to different scales of values the endpoints deal with, for example. Latency data of some endpoints tend to have more variations than latency data of other endpoints. The performance of a machine learning model (such as a representation learning model) with respect to different endpoints may be different. Therefore, a greater new latency data reconstruction error does not necessarily mean the corresponding endpoint is more abnormal (or more suspicious to be the endpoint responsible for an outage). The anomaly score determined according to the dispersion characteristics of the reconstruction error distribution data, as described in the present disclosure, can remove the bias (or misjudgment) caused by comparing the absolute values of new latency data reconstruction errors.

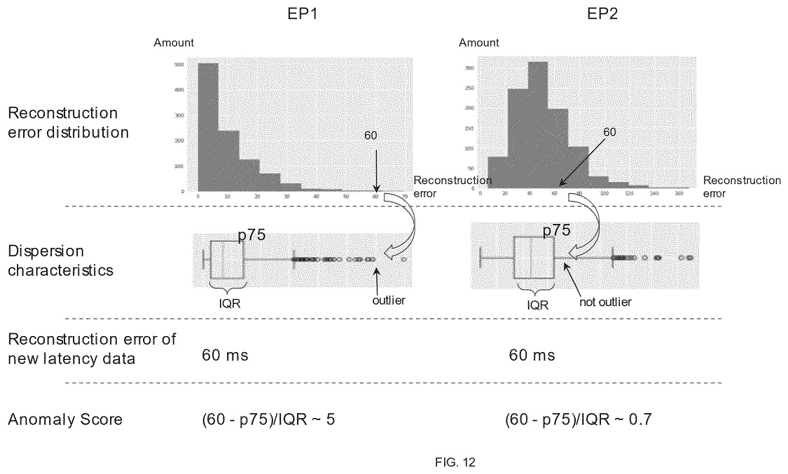

FIG. 12 shows an example of anomaly detection in accordance with some embodiments of the present disclosure.

From the reconstruction error distribution data of EP1 and EP2, we can see that EP2 tends to have greater reconstruction errors. The dispersion characteristics computed from the reconstruction error distribution data are shown in line with the reconstruction error distribution data. The reconstruction error of new latency data of EP1 and the reconstruction error of new latency data of EP2 are computed to be both 60 ms. The anomaly score of EP1 is computed to be around 5. The anomaly score of EP2 is computed to be around 0.7.

In this example, although the absolute values of new latency data reconstruction errors are the same for EP1 and EP2, EP1 would be considered to be more suspicious than EP2 for causing the outage.

In some embodiments, utilizing a TCN-autoencoder in the machine learning model 304 may deliver faster processes (such as training or inference processes), compared with Long Short Term Memory (LSTM) or Gated Recurrent Unit (GRU) networks. In some embodiments, utilizing a TCN-autoencoder in the machine learning model 304 may result in a lighter mechanism or algorithm, compared with a transformer model.

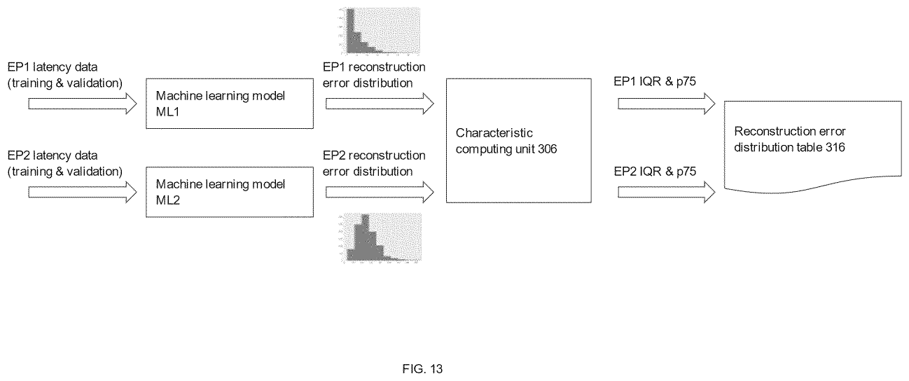

FIG. 13 shows an exemplary data flow in accordance with some embodiments of the present disclosure. Two endpoints are shown here to represent a plurality of endpoints, such as dozens, hundreds or thousands of endpoints. In some embodiments, the data flow in FIG. 13 can be referred to as a training phase of machine learning models.

FIG. 13 is similar to FIG. 4, except that there is one machine learning model corresponding to each endpoint. Each machine learning model could be a representation learning model, such as an autoencoder model. As shown in FIG. 13, the machine learning model ML1 is trained by the training portion of endpoint EP1's latency data. The machine learning model ML1 then takes the validation portion of endpoint EP1's latency data as input, and outputs the corresponding reconstruction error distribution data. The same happens for the endpoint EP2. The characteristic computing unit 306 then computes the IQR and p75 values for each endpoint's reconstruction error distribution data. The IQR and p75 values are then stored in the reconstruction error distribution table 316

In this embodiment, the generation of the reconstruction error distribution data for an endpoint is irrelevant to the latency data of other endpoints.

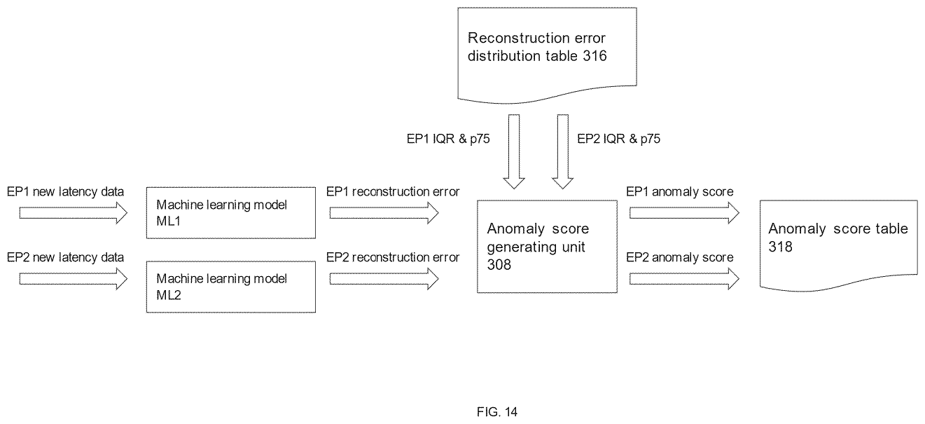

FIG. 14 shows an exemplary data flow in accordance with some embodiments of the present disclosure. Two endpoints are shown here to represent a plurality of endpoints, such as dozens, hundreds or thousands of endpoints. In some embodiments, the data flow in FIG. 13 can be referred to as an inference phase of machine learning models.

FIG. 14 is similar to FIG. 5, except that there is one machine learning model corresponding to each endpoint. Each machine learning model could be a representation learning model, such as an autoencoder model. As shown in FIG. 14, the machine learning model ML1 takes endpoint EP1's new latency data as input, and outputs the corresponding reconstruction error. The machine learning model ML2 takes endpoint EP2's new latency data as input, and outputs the corresponding reconstruction error. Subsequent flows are similar to FIG. 5.

In this embodiment, the generation of the reconstruction error for an endpoint's new latency data is irrelevant to the new latency data of other endpoints. Therefore, the anomaly score of an endpoint is irrelevant to the latency data (or new latency data) of other endpoints.

In the embodiments shown in FIG. 13 and FIG. 14, if there is a new endpoint newly included into the data providing system, the trained machine learning model for each endpoint would not be affected, and can still be used to generate the anomaly scores if any outage occurs.

In some embodiments, there may be preprocesses performed on the latency data of endpoints before inputting into the machine learning model. For example, normalization transformation processes may be performed to further enhance the learning performance of the machine learning model.

In some embodiments, a data length of the new latency data used to generate the reconstruction error is the same as the unit data length of the training set of latency data during the training phase of the machine learning model. In some embodiments, a data length of the new latency data used to generate the reconstruction error is the same as the unit data length of the validation set of latency data used for generating each reconstruction error for the reconstruction error distribution data. In some embodiments, the data length could be, for example, the amount of latency samples in one hour.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

### LIST OF REFERENCE NUMBERS

1 Communication system
10 User terminal
30 Backend server
40 Streaming server
90 Network
200 Endpoint database
300 Server
302 Endpoint monitor
304 Machine learning model
306 Characteristic computing unit
308 Anomaly score generating unit
310 System monitor
312 Correlation computing unit
314 Endpoint data table
316 Reconstruction error distribution table
318 Anomaly score table
320 System data table
322 Correlation table
EP1, EP2, EP3 Endpoint
S600, S602, S604, S606 S608, S610, S612 Step
S614, S616, S618, S620, S622 Step

What is claimed is:

1. A method for anomaly detection, comprising:
obtaining latency data of a first endpoint;
obtaining latency data of a second endpoint;
generating, by a representation learning model, reconstruction error distribution data of the latency data of the first endpoint according to the latency data of the first endpoint and the latency data of the second endpoint;
obtaining new latency data of the first endpoint;
obtaining new latency data of the second endpoint;
generating, by the representation learning model, a reconstruction error of the new latency data of the first endpoint according to the new latency data of the first endpoint and the new latency data of the second endpoint; and
generating an anomaly score for the first endpoint according to a dispersion characteristic of the reconstruction error distribution data and the reconstruction error.

2. The method according to claim 1, wherein the representation learning model is a TCN autoencoder model, and the reconstruction error distribution data of the latency data of the first endpoint is generated by inputting the latency data of the first endpoint and the latency data of the second endpoint into the TCN autoencoder model.

3. The method according to claim 1, further comprising:
generating, by the representation learning model, reconstruction error distribution data of the latency data of the second endpoint according to the latency data of the first endpoint and the latency data of the second endpoint.

4. The method according to claim 1, wherein the anomaly score is generated according to an interquartile range and a 75th percentile of the reconstruction error distribution data.

5. The method according to claim 1, wherein the latency data of the first endpoint includes a first training set and a first validation set, the latency data of the second endpoint includes a second training set and a second validation set, the representation learning model is trained by the first training set and the second training set, and the reconstruction error distribution data is generated by inputting the first validation set and the second validation set into the representation learning model.

6. The method according to claim 1, further comprising:
obtaining values of a system parameter;
generating a first correlation value between the values of the system parameter and the new latency data of the first endpoint; and
generating a second correlation value between the values of the system parameter and the new latency data of the second endpoint.

7. The method according to claim 1, further comprising:
obtaining latency data of a plurality of endpoints;
generating reconstruction error distribution data of the latency data of each of the plurality of endpoints according to the latency data of the plurality of endpoints by a TCN autoencoder model;
obtaining new latency data of the plurality of endpoints;
generating a reconstruction error of new latency data of each of the plurality of endpoints according to the new latency data of the plurality of endpoints;
generating an anomaly score for each of the plurality of endpoints according to a dispersion characteristic of the corresponding reconstruction error distribution data and the corresponding reconstruction error;
generating correlation data for each of the plurality of endpoints according to new latency data of the corresponding endpoint and a system parameter;
filtering the plurality of endpoints according to the anomaly score for each of the plurality of endpoints to create a first group of endpoints; and
filtering the first group of endpoints according to the correlation data for each of the first group of endpoints to create a second group of endpoints.

8. A system for anomaly detection, comprising one or a plurality of processors, wherein the one or plurality of processors execute a machine-readable instruction to perform:
obtaining latency data of a first endpoint;
obtaining latency data of a second endpoint;
generating, by a representation learning model, reconstruction error distribution data of the latency data of the first endpoint according to the latency data of the first endpoint and the latency data of the second endpoint;
obtaining new latency data of the first endpoint;
obtaining new latency data of the second endpoint;
generating, by the representation learning model, a reconstruction error of the new latency data of the first endpoint according to the new latency data of the first endpoint and the new latency data of the second endpoint; and
generating an anomaly score for the first endpoint according to a dispersion characteristic of the reconstruction error distribution data and the reconstruction error.

9. The system according to claim 8, wherein the one or plurality of processors execute the machine-readable instruction to further perform:
generating, by the representation learning model, reconstruction error distribution data of the latency data of the second endpoint according to the latency data of the first endpoint and the latency data of the second endpoint.

10. A non-transitory computer-readable medium including a program for anomaly detection, wherein the program causes one or a plurality of computers to execute:
obtaining latency data of a first endpoint;
obtaining latency data of a second endpoint;
generating, by a representation learning model, reconstruction error distribution data of the latency data of the first endpoint according to the latency data of the first endpoint and the latency data of the second endpoint;
obtaining new latency data of the first endpoint;
obtaining new latency data of the second endpoint;
generating, by the representation learning model, a reconstruction error of the new latency data of the first endpoint according to the new latency data of the first endpoint and the new latency data of the second endpoint; and
generating an anomaly score for the first endpoint according to a dispersion characteristic of the reconstruction error distribution data and the reconstruction error.
